(19) United States
(12) Patent Application Publication
(10) Pub. No.: US 2026/0121359 A1
(43) Pub. Date: Apr. 30, 2026

(54) HIGH POWER ELECTRICAL CONNECTOR

(71) Applicant: Anderson Power Products, Inc., Sterling, MA (US)

(72) Inventor: Jia Li, Sterling, MA (US)

(21) Appl. No.: 19/374,842

(22) Filed: Oct. 30, 2025

Related U.S. Application Data
(60) Provisional application No. 63/714,584, filed on Oct. 31, 2024.

(51) Int. Cl. H01R 13/66; H01R 13/53; H01R 13/627

(52) U.S. Cl. CPC H01R 13/6683; H01R 13/53; H01R 13/6275; H01R 13/6691

(57) ABSTRACT

A modular electrical connector system includes a plug connector and a receptacle connector, each having a housing with a forward-facing mating interface and an open rear. Removable connection modules are inserted through the open rear and fixed within each housing. Each connection module comprises an insulative contact holder defining at least one longitudinal channel, at least one power contact disposed in the channel, a plurality of data contacts in a predetermined pattern, a thermally-conductive clip positioned between the power contact and a wall of the channel. A temperature sensor is mounted to the contact holder and thermally coupled to the clip for monitoring the temperature of the power contact. The connection modules are independently removable and interchangeable by a user, permitting customization of the quantity and arrangement of power and data contacts while re-using the same plug and receptacle housings.

### CROSS REFERENCE TO RELATED APPLICATION

This application is a non-provisional application claiming priority from U.S. Provisional Application Ser. No. 63/714,584, filed Oct. 31, 2024, which is incorporated herein by reference in its entirety.

### FIELD OF THE DISCLOSURE

The present disclosure generally relates to electrical connectors, including connectors for high-power applications.

### BACKGROUND OF RELATED ART

High power electrical connectors are generally known in the industry. However, known connectors do not provide for the novel features of the present invention.

For example, U.S. Pat. No. 10,985,507 describes a connector part for connecting to a mating connector part includes: a housing part; an electrical contact element arranged on the housing part for making electrical contact with the mating connector part; and a temperature monitoring device having a sensor device for detecting a heating on the contact element. The temperature monitoring device includes a carrier element which extends flatly along a plane, on which the sensor device is arranged, and which has two clip arms via which the carrier element is clippable onto the contact element.

WO 2002013330, meanwhile, describes a connector, comprising a housing with several sockets extending in the longitudinal direction thereof, with contacts arranged therein, with the free external ends of the contacts embodied in the form of a sleeve or shell for the accommodation of contact pins. At least one of the contacts is provided with a temperature sensor, where a clip-like holder is preloaded in such a way that the sensor rests against the outer surface of the contact.

Still further, WO 2020020591 relates to a plug-in connector for disconnecting and connecting at least one electrical contact for charging a rechargeable battery unit of a motor vehicle, having at least one electrically conductive contact element, and at least one temperature sensor element for detecting a temperature of the electrically conductive contact element. The temperature sensor element comprises a substrate with a first connection element and a second connection element which is arranged on said first connection element, a flip-chip measuring element and a first conductor track section which is designed as a heat retarder. A first connection of the flip-chip measuring element is electrically connected to the first connection element by means of the first conductor track section which is designed as a heat retarder.

At the same time, DE 102020126192 describes a temperature sensing device for a connector having a latching element for mounting to a contact element of the connector and a temperature sensor. The latching element is made of metal, and the temperature sensor is attached to the latching element by a sensor holder.

Finally, U.S. Pat. No. 10,777,944 describes a plug module including a sensor device and a plug housing. The plug housing includes a socket, an inner side of which includes a receptacle area for accommodating the sensor device, and a cover that is connected to the socket with the aid of a fastening device. A plurality of electrically conductive straight contact pins are introduced into the cover in such a way that first ends of the contact pins protrude into an internal volume of the plug housing and are situated above the receptacle area of the socket, and second ends of the contact pins are situated in the area of a connector of the cover.

While the above identified references may be sufficient for their described purposes, there remains a need in the art for a solution as provided in the present disclosure.

### BRIEF DESCRIPTION OF THE DRAWINGS

FIG. 1A is a perspective view of an example electrical connector system.

FIG. 1B is a perspective view of the electrical connector system of FIG. 1A, with handles removed for clarity of illustration of other components.

FIG. 2A is a front view of an example electrical connector housing that may find use in the connector system of FIG. 1.

FIG. 2B is a front view of an example electrical connector that may find use in the connector system of FIG. 1.

FIG. 2C is a front view of an example electrical connector that may find use in the connector system of FIG. 1.

FIG. 3 is a cross-sectional view of the example electrical connector of FIG. 2C.

FIGS. 4A and 4B are perspective views of an example connection module of the electrical connector of FIG. 2C.

FIGS. 5A and 5B are perspective view of an example connection module that may find use with the connector system of FIG. 1.

FIG. 6 is a perspective view of the plug connector and associated handle of the system of FIG. 1.

FIG. 7 is a perspective view of the receptacle connector and associated handle of the system of FIG. 1.

FIG. 8 is a cross-sectional view of the plug connector handle of FIG. 6, coupled to the receptacle connector of FIG. 7.

FIG. 9 is a perspective view of the receptacle connector handle of FIG. 7.

FIG. 10 is a side view of the plug connector and associated handle of the system of FIG. 1.

FIG. 11 is a perspective view of the plug connector handle of FIG. 6.

FIG. 12 is a cross-sectional view of the plug connector handle of FIG. 6.

FIG. 13 is a perspective view of a latching portion of the plug connector handle of FIG. 6.

FIGS. 14-16 are perspective views of a main portion of the plug connector handle of FIG. 6.

FIG. 17 is an end cross-sectional view of an example connection module including a temperature sensor.

FIG. 18 is a perspective cross-sectional view of a portion of the example connection module including temperature sensor of FIG. 17.

FIG. 19 is a perspective view of a thermally-conductive clip that may find use with the temperature sensor of FIG. 17.

FIG. 20 is an enlarged perspective view of a portion of a connector, illustrating the interface of a temperature sensor clip and a contact holder.

### DETAILED DESCRIPTION

The following description of example methods and apparatus is not intended to limit the scope of the description to the precise form or forms detailed herein. Instead, the following description is intended to be illustrative so that others may follow its teachings.

Electrical connectors typically include a plug and receptacle, each having a number of electrical pins or connections predetermined for a corresponding number of power and/or data signals. The number of connections is generally determined at the time of manufacture, requiring a user to acquire different form factors and connector bodies for different applications. The instant disclosure provides a swappable pin module that enables an end user to assemble a connector, such that the same connector body may be used for a variety of different pin configurations that may be selected at the time of installation and assembly.

In some applications, particularly high-power applications, electrical connectors may be relatively large and may be secured to each other (i.e., a plug to a receptacle) with a relatively high degree of security. Accordingly, such connectors may benefit from a handle to enable a user to more easily manipulate the connector and to provide leverage for the user to connect and disconnect connectors to and from each other. In some embodiments, the connector may also include a latch having a release switch coupled to the handle, enabling a user to release the latch and pull the connectors apart in one motion.

Monitoring the temperature of an electrical connection within an electrical connector can assist with ensuring that the connection is of sufficient quality. For example, an unexpectedly high temperature may indicate a degraded pin or other physical flaw in the connection, or of a power source supplying a quantity of current that could be harmful to the system, or of another problem. The instant disclosure provides a structure for directly monitoring the temperature of power contacts in a connector.

In short, the following disclosure provides for an electrically-conductive clip that is placed in contact with each power-transmitting contact in the connector, and a respective temperature sensor for each clip is encapsulated in the housing and connected to its clip. Additionally, in some examples a signal wire for each sensor extends out of the housing.

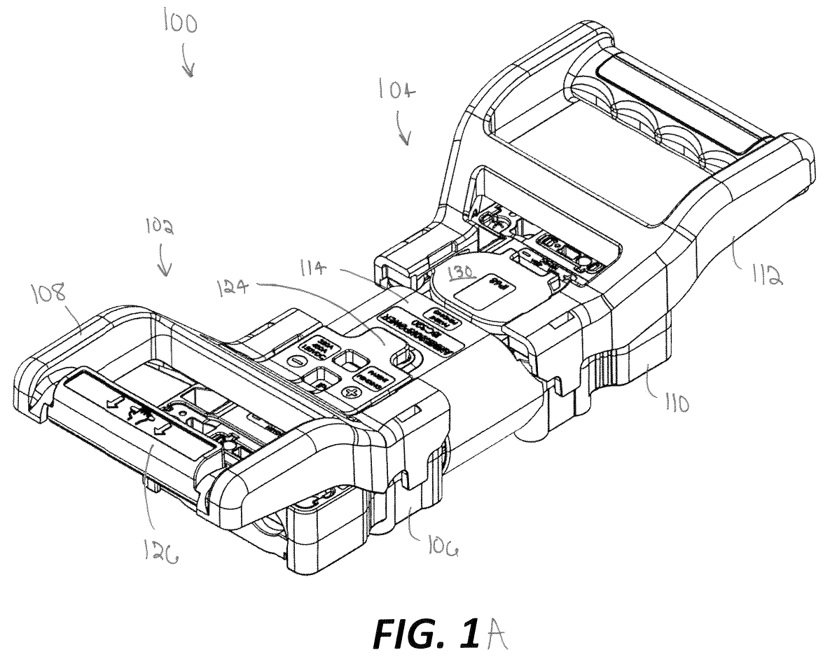

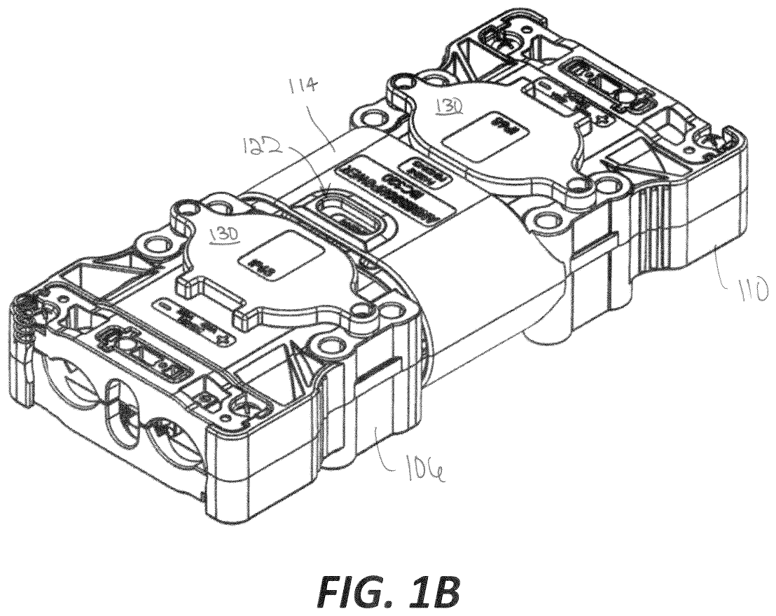

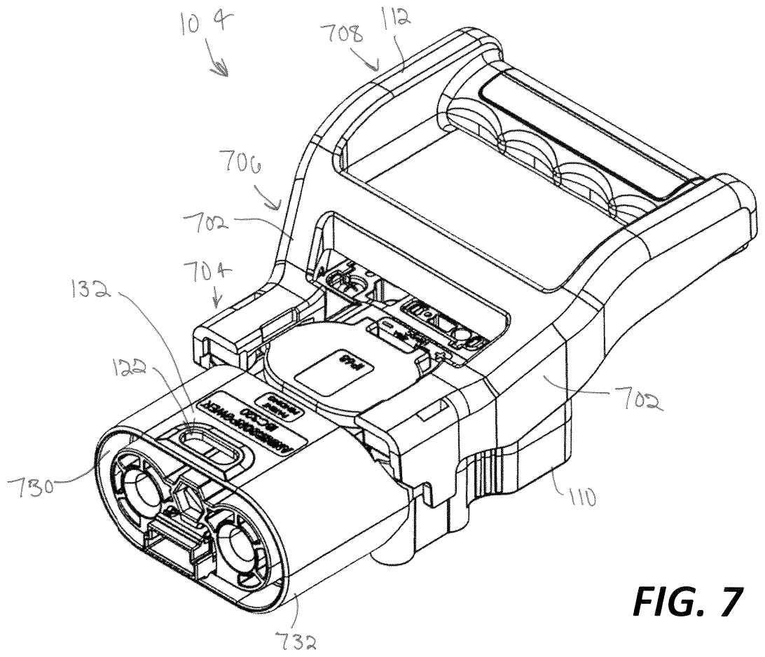

Referring to the drawings, wherein like numerals refer to the same or similar features in the various views, FIGS. 1A and 1B illustrate a connector system 100 that includes a plug connector 102 and a receptacle connector 104. The plug connector 102 includes a plug body 106 and a detachable plug handle 108. Similarly, the receptacle connector 104 includes a receptacle body 110 and a detachable receptacle handle 112. The connector system 100 further includes a latching mechanism 120 that includes a recess 122 (obscured in FIG. 1A but shown in FIGS. 1B and 7) on an upper exterior surface 114 of the receptacle body 110, a latch 124 disposed on the plug handle 108, and a release button 126 also disposed on the plug handle 108. In some embodiments, the latch 124 and release button 126 may be provided on the receptacle handle 112, and the recess 122 on the plug body 106.

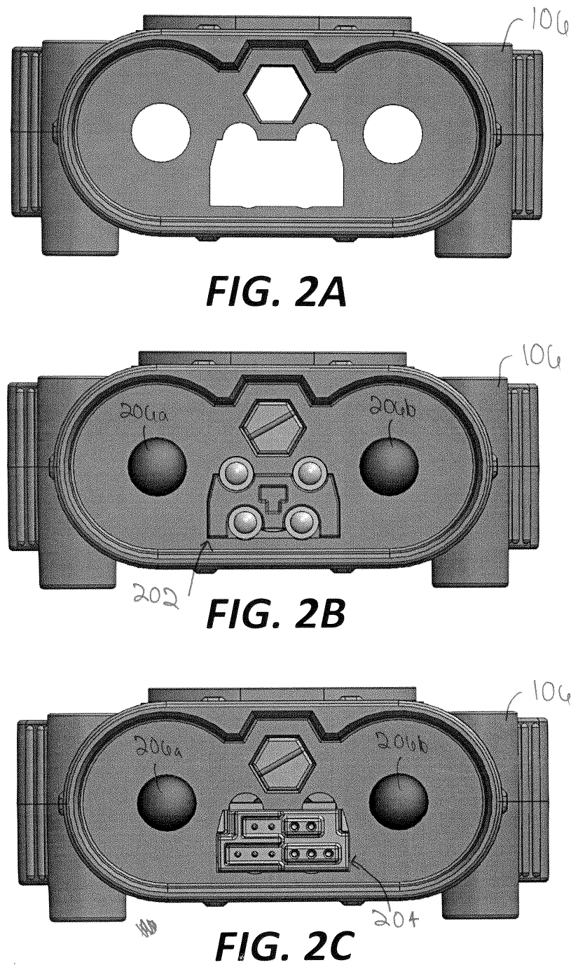

Each of the plug connector 102 and receptacle connector 104 may include a pin and connections arrangement that can be selected and assembled by the end user from among a plurality of pin and connection arrangements, using a universally constructed one of the plug body 106 and/or the receptacle body 110. As shown in FIGS. 2A-2C, for example, the plug body 106 may accommodate a four-pin data connection 202 or a ten-pin data connection 204, both with a first power connection pin 206a and a second power connection pin 206b.

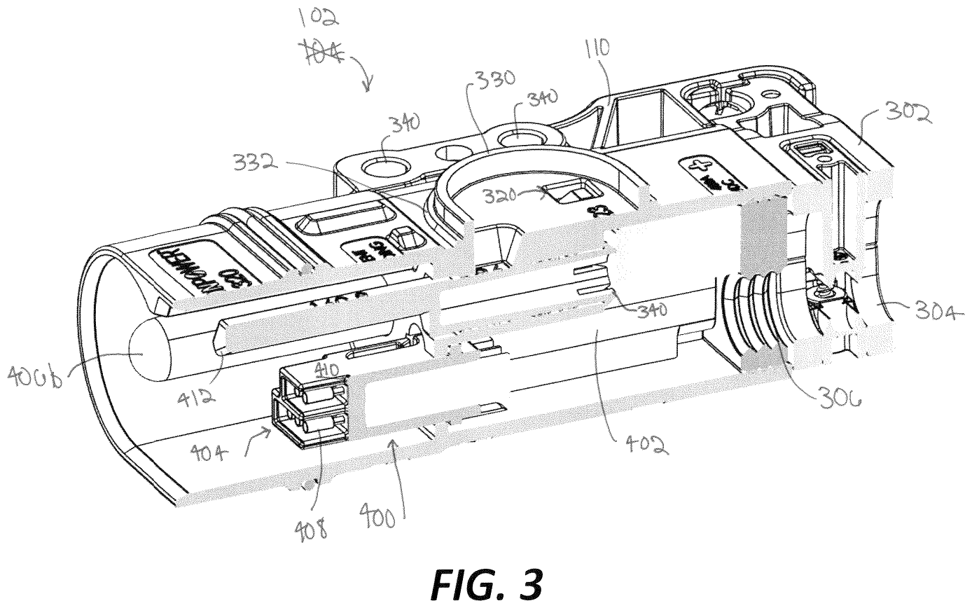

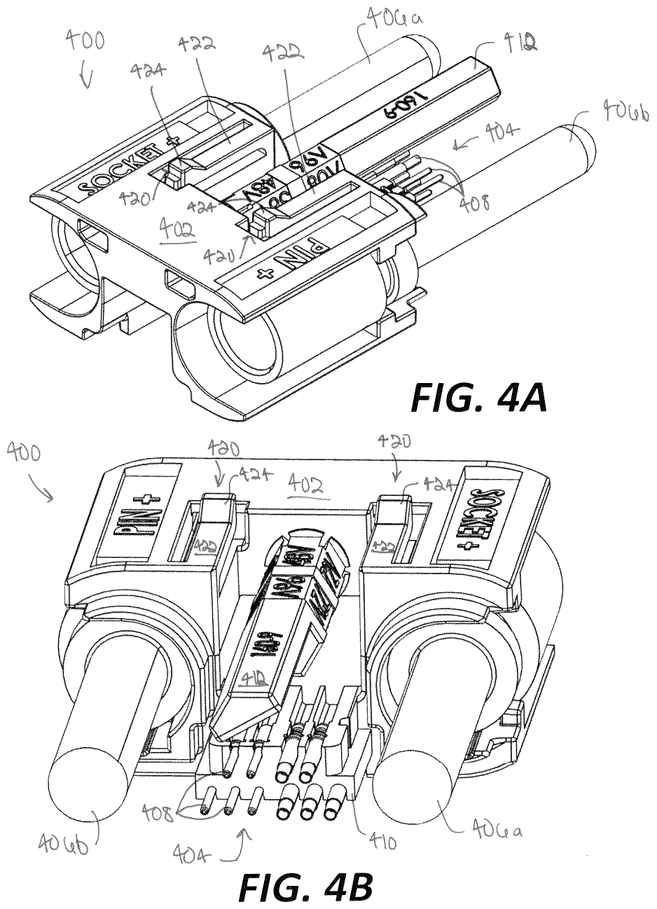

The pin and connection arrangement may be provided in a connection module that can be inserted into the connector body by the end user. FIG. 3 is a cross-sectional view of the plug connector 102, with the plug handle 108 removed, and including a connection module 400. FIGS. 4A and 4B are perspective views of the connection module 400. Referring to FIGS. 3, 4A, and 4B, the connection module 400 may include a contact holder 402, two power pins 406a, 406b coupled to the contact holder 402, and a ten data pin module 404 with ten data pins 408 and a data pin housing 410, with the data pin housing 410 also coupled to the contact holder 402. The connection module 400 may also include a voltage key 412.

The data pins 408 and the power pins 406a, 406b may be coupled to electrical conductors that may extend out of the back of the plug connector 102 as one or more wires or cables for connection to power or data sources or destinations. Such wires and cables may be added by the user at the time of assembly.

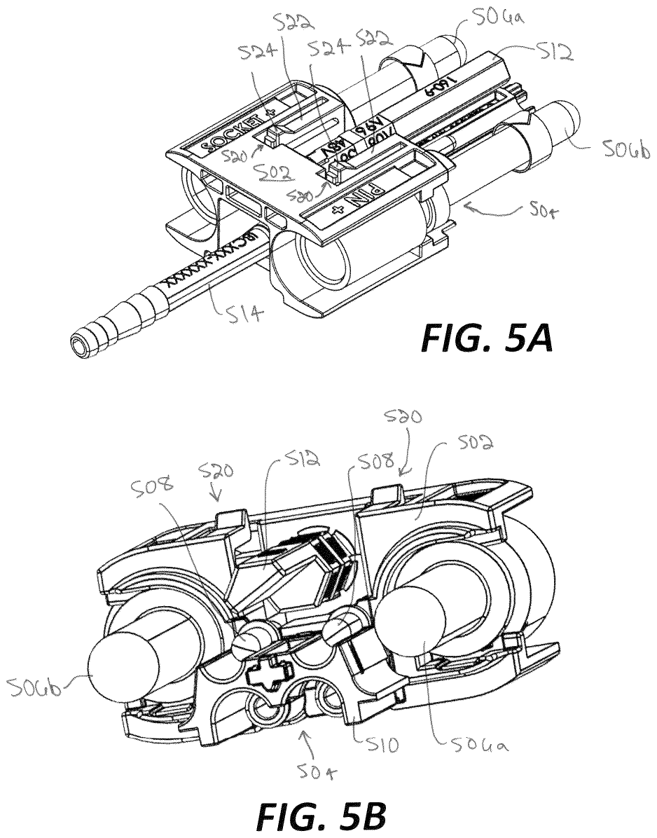

FIGS. 5A and 5B are perspective views of an alternative connection module 500 that includes a contact holder 502, two power pins 506a, 506b coupled to the contact holder 502, and a two data pin module 504 with two data pins 508, an air supply tube 514, and a data pin housing 510, with the data pin housing 510 also coupled to the contact holder 502. The connection module 500 may also include a voltage key 512.

Each of the connection modules 400, 500 may have a corresponding, mating connection module for inclusion in the receptacle connector 104.

A connection module 400, 500 may be inserted into the receptacle body 110 at a time of assembly, by an end user, in some embodiments. For example, the contact holder 402, 502, including the coupled power pins 406, 506 and data pin module 404, 504, may be inserted through the back of the receptacle body 110 with a first clamp 302 and a second clamp 304 opened and a grommet 306 removed. After the contact holder 402, 502 is inserted and any associated wires and cables are coupled and threaded through the receptacle body 110, the grommet 306 may be inserted and the first clamp 302 and the second clamp 304 may be coupled to the receptacle body 110 and closed with a plurality of fasteners.

The contact holder 402, 502 may include one or more (e.g., two) resilient coupling members 420, 520 that are configured to engage with respective coupling apertures 320 on the receptacle body 110. Each coupling member 420, 520 may include a flexible arm 422, 522 and a ramped protrusion 424, 524 at the end of the arm 422, 522. As the contact holder 402, 502 is inserted into the receptacle body 110, the ramped protrusion 424, 524 may slide along an inner surface of the receptacle body 110 and cause the arm 422, 522 to flex inward. When the contact holder 402, 502 is inserted to a position where the ramped protrusion 424, 524 meets the aperture 320, the arm 422, 522 may return to its nominal position. The ramped protrusion 424, 524 may impede removal of the contact holder 402, 502 once it is secured in the aperture 320.

As shown in FIG. 1, the receptacle connector 104 may include an upper cover 130 that is removably disposed over the coupling apertures 320. The plug connector 102 may include an identical or similar upper cover 130. In some embodiments, the upper cover 130 may be placed about a raised circumferential protrusion 330 (see FIG. 3) that surrounds the coupling apertures 320. In some embodiments, a gasket 332 may be disposed between the raised protrusion 330 and the upper cover 130 to provide fluid sealing.

Also during assembly, the voltage key 412, 512 may be inserted through the front of the receptacle body 110. The voltage key 412, 512 may couple with the receptacle body 110 via a flexible snap-fit member 340 at a rear of the voltage key.

For an assembly, a user may select a desired connection module 400, 500 (or other) from a plurality of connection modules. For example, the user may select a connection module 400 with ten data pins from a set of connection modules, one 400 having ten data pins, another 500 having two data pins and an air tube, another having four data pins, another having six data pins, and so on. The user may insert the selected connection module 400 into the connector body as described above. For an assembly for another desired connector, the user may instead select the connection module having two data pins and an air tube and insert that selected connection module into another, identical, housing as described above. Thus, a single housing can accommodate a variety of different quantities of connections through the use of insertable connection modules.

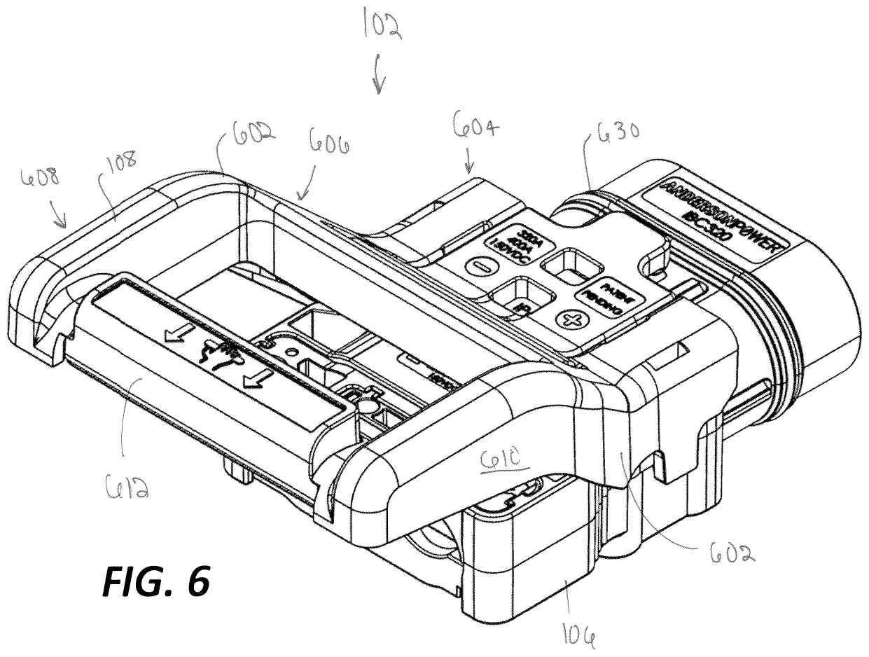

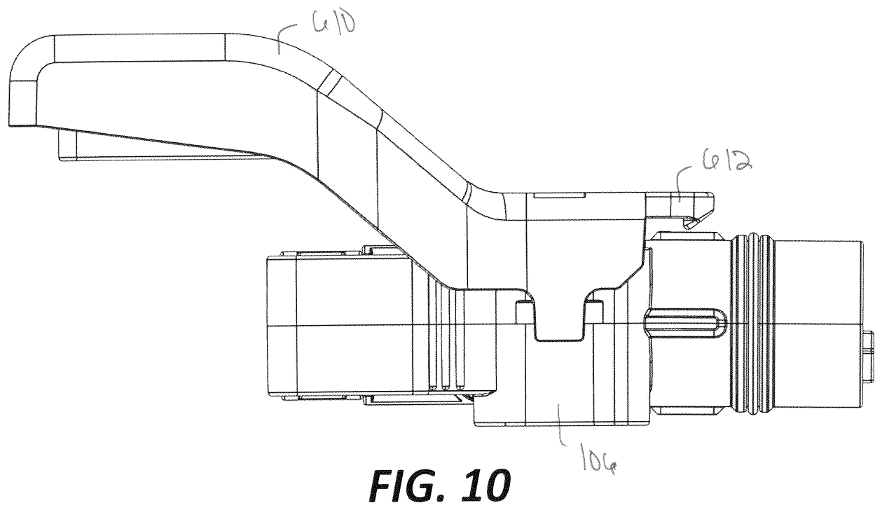

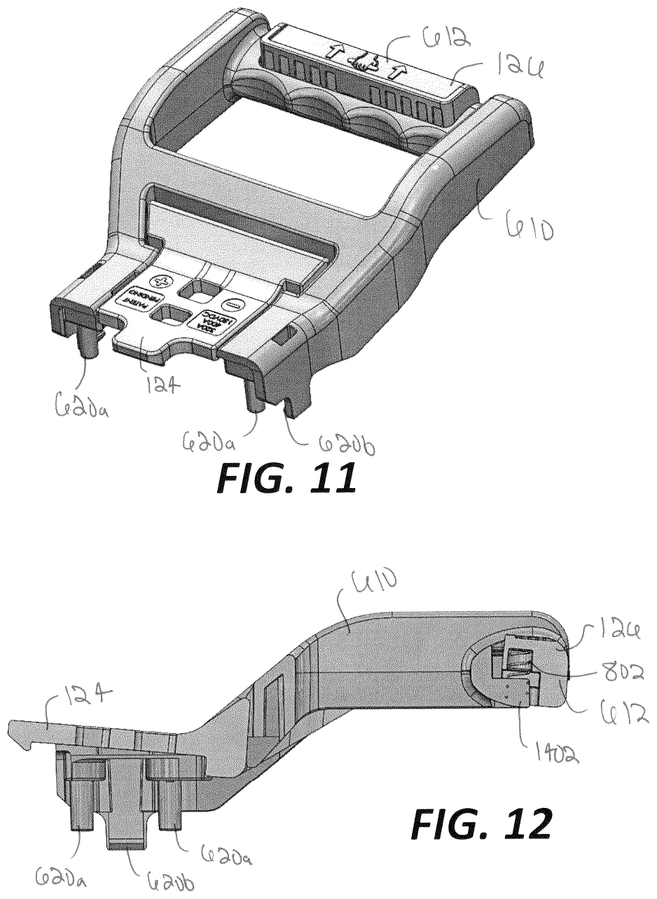

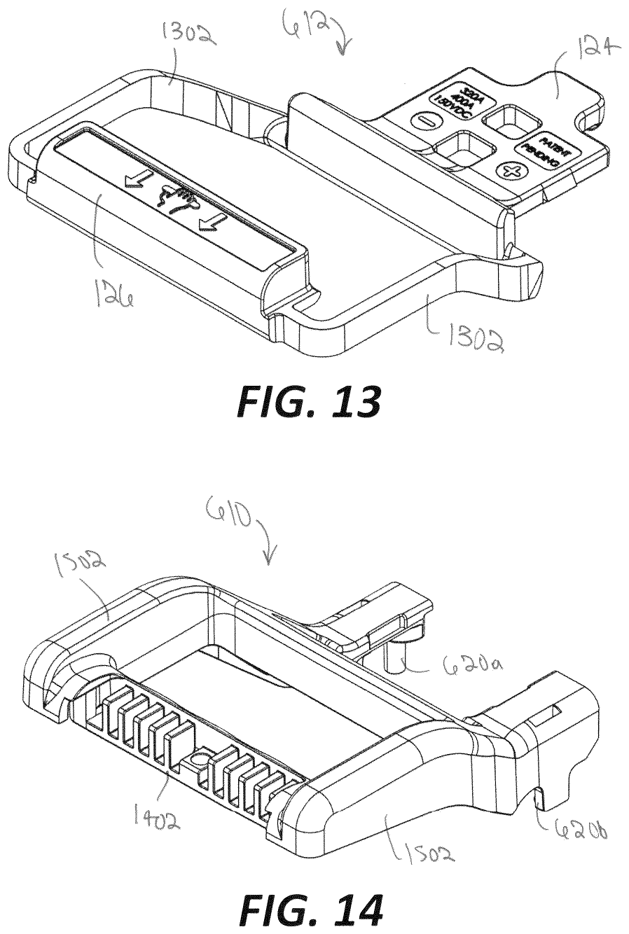

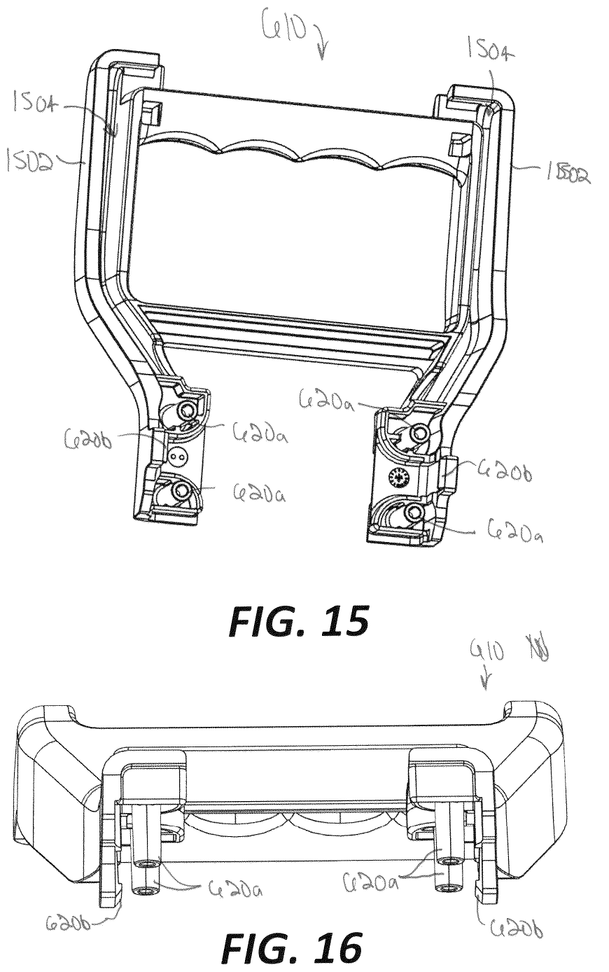

FIGS. 6-12 illustrate the plug connector 102, the receptacle connector 104, the plug handle 108, and the receptacle handle 112 in detail. As noted above, the plug handle 108 and the receptacle handle 112 may provide a user with improved leverage when coupling the plug connector 102 and the receptacle connector 104 together and/or when separating the plug connector 102 and the receptacle connector 104 from each other.

Each of the plug handle 108 and the receptacle handle 112 may include a first longitudinal arm 602 and a second longitudinal arm 702 that each extend rearward and upward from a coupled set of the plug body 106 and the receptacle body 110. For example, the plug handle 108 and the receptacle handle 112 may include a first forward parallel portion 604 and a second forward parallel portion 704 that generally extends parallel to a coupling direction of the plug connector 102 and the receptacle connector 104 (i.e., a direction along which the plug connector 102 and the receptacle connector 104 are coupled together), an angled portion 606, 706 that generally extends at an angle relative to the connector coupling direction, and a rear parallel portion 608, 708 that also extends parallel to the connector coupling direction. The angled portion 606, 706 may be disposed between and may be contiguous with the forward and rear parallel portions 604, 608 and 704, 708. The rear parallel portion 608, 708 may extend rearward beyond a rearmost portion of the plug body 106 and the receptacle body 110, in some embodiments. The angled portion 606, 706 may meet the rear parallel portion 608, 708 at a location that is rearward of the rearmost portion of the plug body 106 and the receptacle body 110, in some embodiments.

The shape of the handle—with the rear parallel portion 608, 708 disposed both rearward of the plug body 106 and the receptacle body 110 and with vertical separation from the plug body 106 and the receptacle body 110—may provide improved leverage to a user when connecting and disconnecting the plug connector 102 and the receptacle connector 104 to and from one another, relative to known handles.

The plug handle 108 may include a main portion 610 and a latching portion 612. The main portion 610 may be coupled to the plug body 106 and may be stationary with respect to the plug body 106 once coupled. Accordingly, the handle main portion 610 may include a plurality of coupling projections 620 that mate with corresponding features on the plug body 106. In some embodiments, the handle main portion 610 may define a plurality of (e.g., four) cylindrical vertical protrusions 620a that are inserted into corresponding apertures 340 (see FIGS. 1B and 3) in a top surface of the receptacle body 110 and two lateral ramped protrusions 620b that mate with corresponding lips of the upper cover 130 (see FIG. 1B) or indents on the lateral sides of the plug body 106. The main portion 610 may be formed from a monolithic body of material.

The latching portion 612 may include the latch 124 and the release button 126 and may be formed from a monolithic body of material. In the angled portion 606 and the rear parallel portions 608 of the handle, the latching portion 612 may define arms 1302 that are disposed within recesses 1504 of arms 1502 of the main portion 610. The latch 124 may be provided on the forward parallel portion 604 of the plug handle 108. The release button 126 may be provided on the rear parallel portion 608 of the plug handle 108. The latch 124 and release button 126 may be formed from a monolithic, rigid body of material, such that downward movement of the release button 126 causes the latch 124 to raise away from the plug body 106.

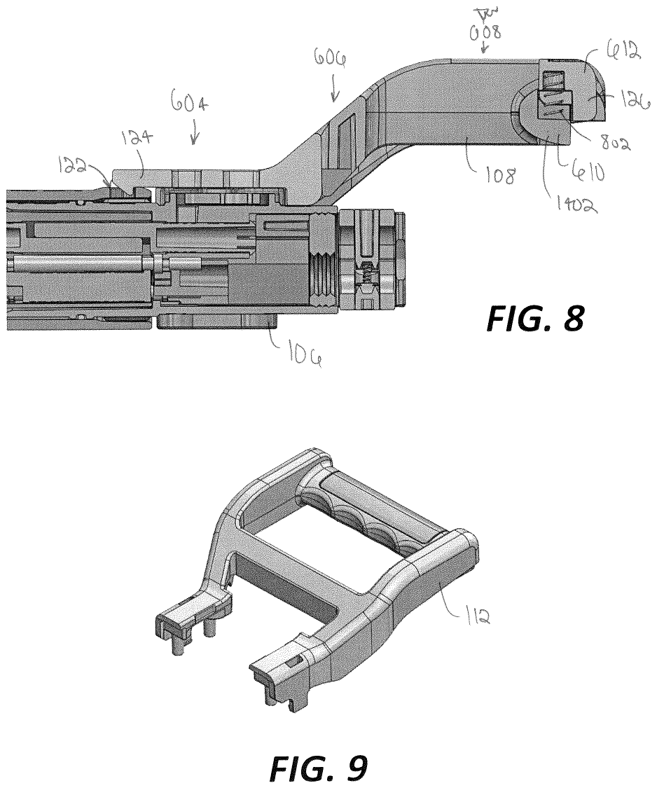

The release button 126 may be or may include a laterally-extending member that extends from one arm 1302 of the handle to the other arm 1302 of the handle. The main portion 610 may similarly include a laterally-extending member 1402 that extends from one arm 1502 of the handle to the other arm 1502 of the handle. The release button 126 may be disposed vertically above the laterally-extending member 1402 of the main portion 610. A spring 802 (see FIGS. 8, 12) may be disposed between the release button 126 and the laterally-extending member 1402 of the main portion 610 that biases the release button 126 away from the laterally-extending member 1402 of the main portion 610, and thus biases the latch 124 downward and towards a closed position when the plug handle 108 is coupled to the plug body 106.

The connector system 100 may provide a high degree of sealing against foreign bodies and fluids. For example, the plug connector 102 may include one or more circumferential gaskets 630 that may seal against an inner surface 730 of a shroud 732 of the receptacle connector 104 when the plug connector 102 and the receptacle connector 104 are coupled together. The shroud 732 may include the upper exterior surface 114, in some embodiments.

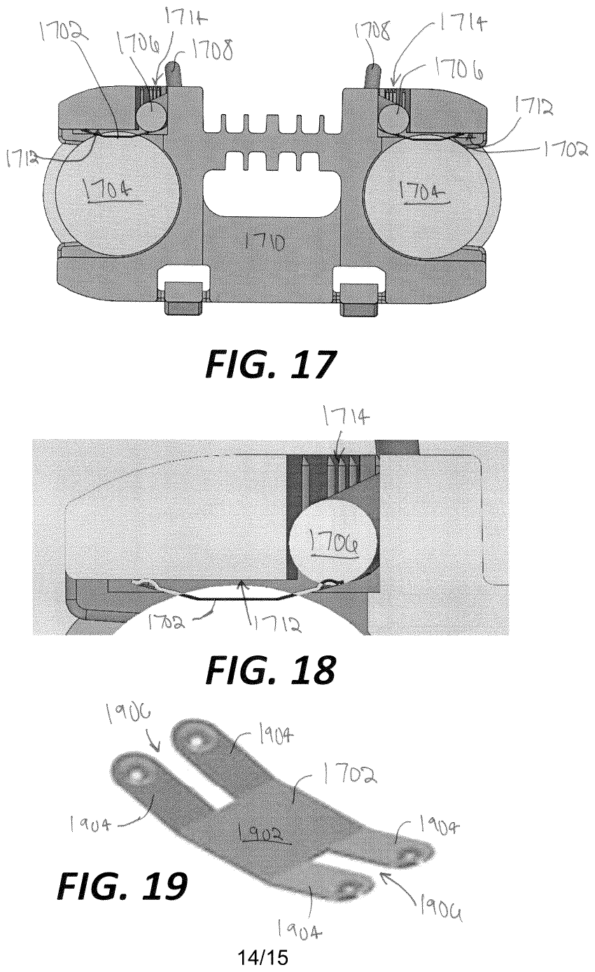

FIGS. 17-20 illustrate a temperature monitoring system that may be included in the plug connector 102 and/or the receptacle connector 104. The temperature monitoring system may include an electrically-conductive and thermally-conductive plate or clip 1702 that is in contact with the electrical contact 1704 (which may be, for example, the first power connection pin 206a, the second power connection pin 206b, the two power pins 406a, the two power pins 406b, the two power pins 506a, and/or the two power pins 506b) of the plug connector 102 and the receptacle connector 104. The clip 1702 may be electrically coupled to a temperature sensor 1706 (e.g., thermocouple, thermistor, etc.), further coupled to a conductor lead 1708 that extends out of the connector.

The clip 1702 may include a main body portion 1902 and a plurality of arms 1904 that extend from the periphery of the main body portion 1902. The arms 1904 may be affixed to the contact holder 1710, such that the main body portion 1902 of the clip 1702 may flex to securely contact an inserted electrical contact 1704. One or more arms 1904 of the clip may extend into a longitudinal channel 1714 defined in the contact holder 1710.

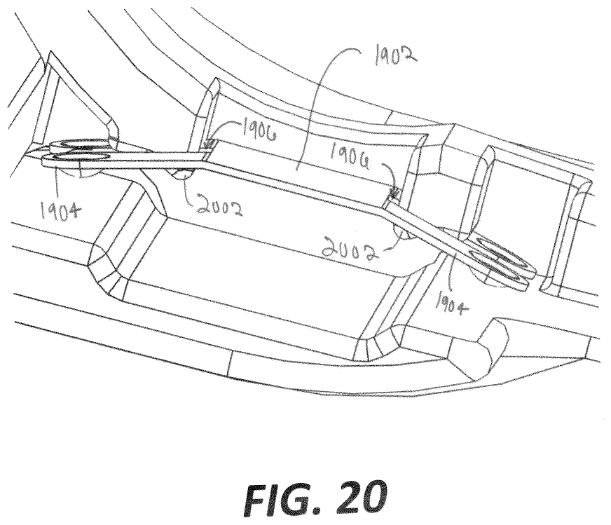

The clip 1702 may be disposed on an inner surface 1712 of a contact holder 1710 (which may be, for example, a contact holder 402, 502), between the inner surface 1712 and a power contact 1704 or other contact disposed in the contact holder 1710. The clip 1702 may be affixed to the contact holder 1710 through friction fit, adhesive, one or more fasteners, and/or another affixation means. For example, as shown in FIG. 20, the contact holder 1710 may define one or more vertical protrusions 2002 that may extend through gaps 1906 between the arms 1904.

The temperature sensor 1706 may be disposed in the channel 1714, and the channel 1714 may extend longitudinally (along the coupling direction) to the rear of the connector. The conductor lead 1708 may be coupled to the sensor 1706 within the channel 1714 and may extend out of the rear of the channel 1714, where a temperature monitoring processor or other hardware may be coupled with the conductor lead 1708 for receiving data from the temperature sensor 1706.

In the embodiment of FIGS. 17-20, two clips 1702, two temperature sensors 1706, and two conductor leads 1708 are provided, respectively for two electrical contacts 1704. In other embodiments, more or fewer clips 1702 and associated sensors 1706 and conductor leads 1708 may be provided according to the number of electrical contacts provided.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. A modular electrical connector system, comprising:
a plug connector including a plug housing having a forward-facing mating interface and an open plug rear, and a first connection module removably insertable through the open plug rear and fixed within the plug housing, the first connection module including:
an insulative plug contact holder;
at least one plug power contact retained by the plug contact holder; and
a plurality of plug data contacts retained by the plug contact holder in a predetermined pattern;
a receptacle connector including a receptacle housing having a complementary mating interface and an open receptacle rear, and a second removable connection module inserted through the open receptacle rear and fixed within the receptacle housing, the second connection module being matingly complementary to the first connection module and including:
an insulative receptacle contact holder;
at least one receptacle power contact retained by the receptacle contact holder; and
a plurality of receptacle data contacts retained by the contact holder in the predetermined pattern; and
wherein the first and second connection modules are independently removable and interchangeable allowing customization of quantity and arrangement of the plug power contact and the receptacle power contact while re-using the same plug housing and the same receptacle housing.

2. The modular electrical connector system of claim 1, wherein each contact holder includes at least one resilient coupling member that engages a corresponding aperture in the respective housing to retain the connection module in place.

3. The modular electrical connector system of claim 1, further comprising a voltage-rating element insertable from a front side of at least one of the housings and snap-fitted thereto to indicate a voltage rating of the assembled connector.

4. The modular electrical connector system of claim 1, wherein the predetermined pattern of data contacts is selectable from among at least: two data contacts and an air-supply tube, four data contacts, and ten data contacts.

5. The modular electrical connector system of claim 1, further comprising a circumferential gasket disposed around the mating interface of the plug housing and configured to seal against a shroud of the receptacle housing when the plug connector and the receptacle connector are mated.

6. A contact holder assembly for an electrical connector, comprising:
an insulative contact holder defining at least one longitudinal channel;
an electrical contact disposed in the longitudinal channel;
a thermally-conductive clip positioned between the electrical contact and a wall of the longitudinal channel and in thermal engagement with the electrical contact; and
a temperature sensor mounted to the contact holder and thermally coupled to the thermally-conductive clip such that heat from the electrical contact conducts through the clip to the temperature sensor for monitoring a temperature of the electrical contact.

7. The contact holder assembly of claim 6, wherein the thermally-conductive clip comprises a main body portion and a plurality of resilient arms extending from the main body portion, at least one of the arms engaging the contact holder to retain the clip in position.

8. The contact holder assembly of claim 6, wherein the temperature sensor is selected from the group consisting of a thermocouple and a thermistor.

9. The contact holder assembly of claim 6, further comprising a signal lead electrically connected to the temperature sensor and routed through the longitudinal channel to exit a rear end of the contact holder.

10. A modular electrical connector, comprising:
a connector including a housing having a forward-facing mating interface and an open rear, and a removable connection module inserted through the open rear and fixed within the housing, the removable connection module including:
an insulative contact holder defining at least one longitudinal channel;
at least one power contact disposed in the longitudinal channel and retained by the contact holder;
a plurality of data contacts retained by the contact holder in a predetermined pattern; and
a thermally-conductive clip positioned between the at least one power contact and a wall of the longitudinal channel and in thermal engagement with the at least one power contact; and
a temperature sensor mounted to the contact holder and thermally coupled to the thermally-conductive clip such that heat from the at least one power contact conducts through the clip to the temperature sensor for monitoring a temperature of the at least one power contact;
wherein the connection module is independently removable and interchangeable by a user, thereby permitting customization of quantity and arrangement of the power contacts and the data contacts while re-using the same housing.

11. The modular electrical connector of claim 10, wherein the insulative contact holder includes at least one resilient coupling member that engages a corresponding aperture in the housing to retain the connection module in place.

12. The modular electrical connector of claim 10, further comprising a voltage-rating element insertable from a front side of the housing and snap-fitted thereto to indicate a voltage rating of the connector.

13. The modular electrical connector of claim 10, wherein the predetermined pattern of data contacts is selectable from among at least: two data contacts and an air-supply tube, four data contacts, and ten data contacts.

14. The modular electrical connector of claim 10, further comprising a circumferential gasket disposed around the mating interface of the housing and configured to seal against a shroud of a corresponding housing when the connector is mated to a corresponding connector.

15. The modular electrical connector of claim 10, wherein the thermally-conductive clip comprises a main body portion and a plurality of resilient arms extending from the main body portion, at least one of the arms engaging the contact holder to retain the clip in position.

16. The modular electrical connector of claim 10, wherein the temperature sensor is a thermocouple or a thermistor.

17. The modular electrical connector of claim 10, further comprising a signal lead electrically connected to the temperature sensor and routed through the longitudinal channel to exit a rear end of the contact holder.

18. The modular electrical connector of claim 10, further comprising:
a handle assembly including:
a pair of longitudinal arms each having a forward portion extending generally parallel to a connector mating axis, an angled intermediate portion, and a rear portion extending generally parallel to the mating axis;
a grip spanning between the rear portions of the longitudinal arms;
a latch supported on the forward portions of the longitudinal arms and configured to engage a complementary retention feature on a mating connector;
a release button disposed on the grip and connected to the latch through the longitudinal arms; and
a spring biasing the release button away from the grip so that the latch is biased toward an engaged position, the release button being manually depressible to retract the latch against the spring and release the connector.

19. The modular electrical connector of claim 18, wherein the latch and the release button are formed as a monolithic, rigid body extending through the longitudinal arms.

20. The modular electrical connector of claim 18, wherein the longitudinal arms include coupling projections configured to be snap-fitted into corresponding apertures of the connector housing to enable removal of the handle assembly without tools.
